(19) United States
(12) Patent Application Publication
(10) Pub. No.: US 2020/0223417 A1
(43) Pub. Date: Jul. 16, 2020

(54) ELECTRICAL BRAKE ACTUATOR FOR A MOTOR VEHICLE

(71) Applicant: Brose Fahrzeugteile SE & Co. Kommanditgesellschaft, Würzburg, Würzburg (DE)

(72) Inventors: Christoph OTTO, Ahorn (DE); Michael JACOB, Meura (DE)

(73) Assignee: Brose Fahrzeugteile SE & Co. Kommanditgesellschaft, Würzburg, Würzburg (DE)

(21) Appl. No.: 16/633,442

(22) PCT Filed: Jul. 25, 2018
(86) PCT No.: PCT/EP2018/070104

§ 371 Date: Jan. 23, 2020

(30) Foreign Application Priority Data
Jul. 27, 2017 (DE) 20 2017 104 469.6

(51) Int. Cl. B60T 13/74; F16D 65/16; F16H 1/20

(52) U.S. Cl. CPC B60T 13/746; F16D 2121/24; F16H 1/20; F16D 65/16

(57) ABSTRACT

An electrical brake actuator for a motor vehicle, comprising an actuator housing, which is formed from a first housing half-shell and a second housing half-shell, and comprising an electric motor and a multi-stage transmission, which comprises a first transmission stage driven by the electric motor and a final transmission stage having an output gear. The electric motor comprises a motor housing and a commutator as well as a brush system which comprises a pot-like brush carrier having base-side shaft feedthrough for a motor shaft which has a first pinion fixed to the shaft. A transmission plate is integrally formed on the brush carrier, in particular monolithically, to form a carrier unit, which comprises at least one first bearing seat for receiving a first bearing axis of a first gearwheel of the first transmission stage, said gearwheel meshing with the first pinion fixed to the shaft.

### CROSS-REFERENCE TO RELATED APPLICATIONS

This application is the U.S. National Phase of PCT Application No. PCT/EP2018/070104 filed on Jul. 25, 2018, which claims priority to German Patent Application No. DE 20 2017 104 469.6, filed on Jul. 27, 2017, the disclosures of which are hereby incorporated in their entirety by reference herein.

### TECHNICAL FIELD

The present disclosure relates to an electrical (electric motor-powered) brake actuator for a motor vehicle.

### BACKGROUND

Electrical brake actuators are normally fitted in motor vehicles. For example, an electrical parking brake may be applied and released by means of such a brake actuator. Depending on usage of the brake actuator, this may firstly be operated manually by a user by means of a switch, or secondly be activated or controlled automatically by means of a control unit. Thus for example, automatic release of the parking brake may simplify pulling away, in particular on a gradient, for the user.

Furthermore, because of the electrical control, both a handbrake lever and a connecting cable are no longer required, whereby cost and installation space may be saved.

The use of such a brake actuator is not however restricted to a parking brake. It is for example also conceivable to use these brake actuators for a traction control and electronic stability program (ESP), and in a service brake of the motor vehicle.

### SUMMARY

One or more objects of the present disclosure may be provided by specifying a suitable electrical brake actuator that may be provided with a brush-commutated electric motor and a gear mechanism. A tolerance chain for spacing of the axes of the gear wheels of the corresponding gear stages of the gear mechanism, such as, for a first gear stage, should be as small as possible.

In one or more embodiments, the electrical brake actuator, that may be configured for use in a motor vehicle, may include an actuator housing that may be formed from a first housing half-shell and a second housing half-shell. The electrical brake actuator may include an electric motor, and a multi-stage gear mechanism that may include a first gear stage driven by the electric motor and a final gear stage with an output gear. Here, the electric motor may include a motor housing, a commutator and a brush system with a pot-like brush carrier. As one example, the pot-like brush carrier may include a base with a shaft passage for a motor shaft with a first pinion fixed to the shaft, and a brush carrier sleeve (brush carrier casing) formed on the base and substantially closed around the circumference.

A gear plate may be formed to the brush carrier, such as monolithically, forming a carrier unit: the carrier unit may contain at least one first bearing seat for receiving a first bearing axis of a first gear wheel of the first gear stage. Here, the first gear wheel may mesh with the first pinion fixed to the shaft, and may form the first gear stage.

As one example, mounting the motor shaft (with the first pinion fixed to the shaft) and by mounting the first bearing axis of the first gear wheel (which meshes with the pinion fixed to the shaft) in the same component, namely the carrier unit, a tolerance chain for the spacing of the first bearing axis from the motor shaft may be substantially reduced. In this way, noise development and wear of the first gear wheel, the first pinion and the motor shaft, the first bearing axes and their bearings, may be reduced. Furthermore, because of the monolithic design of the carrier element, comparatively few (mounting) interfaces are required, whereby mounting of the gear mechanism and motor is simplified, resulting in cost-saving production.

A pinion may mean a gear wheel with a smaller number of teeth of a gear stage, wherein in a gear stage with a translation ratio of more than one, the pinion is also the driving gear wheel.

In one or more embodiments, on the base side facing away from the brush carrier sleeve, the brush carrier of the carrier unit may include a bearing receptacle for a shaft bearing. The bearing receptacle may be configured as a molding which is raised on the base side and surrounds the shaft passage in the manner of the sleeve. Here, the shaft bearing may be formed as a plain or sintered bearing.

According to another embodiment, the gear mechanism has a first intermediate stage and a second intermediate stage between the first gear stage and the final gear stage. Here, a respective pinion drives a comparatively large gear wheel, whereby advantageously a comparatively high translation ratio is possible, that may be necessary for operating a brake, as one example.

However, a design without intermediate stage, with a single intermediate stage or with more than two intermediate stages, is also conceivable. Depending on design, a corresponding torque is then applied to the output gear, and the output gear has a corresponding rotation speed. In this way, the brake actuator may be adapted according to a proposed application.

According to one or more embodiments, the first gear wheel may be formed as a ring gear with helical toothing or include a number of helical teeth. In other words, the gear wheel of the first intermediate stage is not designed to be solid. The first gear wheel may be cut out in the manner of a pot so as to save material, and may include internal toothing so that the first pinion (which is fixed on the shaft and meshes with the internal toothing) may be arranged at least partially in the cutout, whereby again advantageously a compact design is possible. Furthermore, because of the helical toothing of the first gear wheel and of the pinion meshing therewith and fixed to the shaft, advantageously noise development is minimized.

In a suitable embodiment, the first gear wheel together with a second pinion of the first intermediate stage forms a first double gear wheel. A double gear wheel here means two spur gears arranged coaxially and rotationally fixed relative to each other, such as, formed integrally i.e. monolithically.

According to another embodiment, a first bearing seat of the first bearing axis is arranged in the brush carrier of the carrier unit. As one example, the bearing axis is here received on a side of the brush carrier opposite the integrally formed gear plate. This ensures that installation space is substantially available in the region of the gear plate for the following gear stages, so as to give a particularly compact design of the gear mechanism. A second bearing seat of the first bearing axis is arranged accordingly in the second housing half-shell of the actuator housing.

According to one or more embodiments, a second bearing axis receives a second double gear wheel with a second gear wheel and a third pinion of the second intermediate stage. The second gear wheel meshes with the second pinion, forming the first intermediate stage.

In one or more embodiments, the second bearing axis may be received by a first bearing seat of the second bearing axis and by a second bearing seat of the second bearing axis. Here, the first bearing seat of the second bearing axis is arranged on a side of the gear plate of the carrier unit facing the second housing half-shell, and the second bearing seat of the second bearing axis is arranged accordingly in the second housing half-shell.

Furthermore, according to an advantageous refinement, the third pinion of the second double gear wheel meshes with at least two double gear wheels of a respective third double gear wheel, forming the second intermediate stage. For the sake of clarity, a design with only two third double gear wheels is explained below.

Here, the two third double gear wheels are each received by a third bearing axis, the first bearing seat of which, in a suitable refinement, is arranged in a side of the gear plate of the carrier unit facing the first housing half-shell, and the second bearing seat of which is arranged accordingly in the first housing half-shell of the actuator housing.

Because of the mounting of the first, second and both third bearing axes in the brush carrier, which is such as, formed monolithically, a tolerance chain for the corresponding gear stages is reduced. This may reduce wear of the respective gear wheels, pinions, bearing axes, and bushings.

According to an advantageous refinement, for as compact as possible a design of the gear mechanism, the gear plate of the carrier unit has a stepped form with a first step region and a second step region, which is spaced from and parallel to the first step region in the direction of the second housing half-shell, and with a connecting region which is arranged substantially perpendicularly thereto. The second double gear wheel and the two third double gear wheels are mounted such that both the pinion of the second double gear wheel and the two gear wheels meshing therewith of the corresponding third double gear wheels are arranged on the gear plate side. The second double gear wheel is arranged on the side facing the second housing half-shell, and the two third double gear wheels are arranged on the side facing the first housing half-shell. Suitably, the second double gear wheel is mounted in the first step region, and the two third double gear wheels are mounted in the second step region. The connecting region of the gear plate is cut out in the region of the third pinion so that, advantageously, the third pinion can mesh with the two third gear wheels.

As one example, in the final gear stage, a respective fourth pinion of each third double gear wheel may mesh with the output gear. Because of this parallel connection, a power split from the third pinion to the output gear may be achieved. In the final gear stage, this may reduce the comparatively high loads caused by operation and the corresponding wear on the fourth pinion and output gear because of the comparatively high torque levels.

According to one or more embodiments, the output gear together with an output pinion forms a fourth double gear wheel. Here, the output pinion may be provided for coupling with an output part. The output part may be a part for coupling with a brake actuator output shaft, or part of a further reduction gear mechanism, such as, a planetary gear mechanism.

In one or more embodiments, the first housing half-shell of the actuator housing may define a passage, raised on the housing inside, for the output pinion of the fourth double gear wheel and for an output gear bearing, for example a plain or sintered bearing.

For mounting the fourth double gear wheel, also, according to a suitable refinement, a fourth bearing axis is formed on the inside of the second housing half-shell of the actuator housing for receiving the output gear.

According to another embodiment, the gear wheels and the pinions of the gear mechanism may be received by means of the bearing axes arranged axially parallel to the motor shaft, whereby the gear mechanism forms a spur gear mechanism. In this way, in particular a compact design of the gear mechanism as possible.

### BRIEF DESCRIPTION OF THE DRAWINGS

An exemplary embodiment of the invention is explained in more detail below with reference to a drawing. The drawings show:

FIG. 1 in exploded perspective view, an electrical (electric motor-driven) brake actuator with a first housing half-shell and a second housing half-shell of an actuator housing, and with a brush-type electric motor and a gear mechanism mounted on a carrier element,

FIG. 2 in an exploded depiction, the gear mechanism of the brake actuator from FIG. 1 with a first bearing axis, a second bearing axis and two third bearing axes, which respectively receive a first double gear wheel, a second double gear wheel and two third double gear wheels, and with a fourth double gear wheel and a first pinion arranged on the motor shaft of the electric motor,

FIG. 3a in enlarged scale, the carrier element from FIG. 1 in a perspective view onto its side facing the electric motor, with a shaft passage and two first bearing seats of the two third bearing axes,

FIG. 3b the carrier element from FIG. 1 in a perspective view onto its side facing away from the electric motor, with a respective first bearing seat of the first bearing axis and of the second bearing axis, and with the first and second bearing axes,

FIG. 4a in top view, the side of the first housing half-shell facing the gear mechanism, with two second bearing seats of the two third bearing axes, and with a passage, and

FIG. 4b in top view, the side of the second housing half-shell facing the gear mechanism, with a respective second bearing seat of the first bearing axis and of the second bearing axis, and with a fourth bearing axis.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

An electrical brake actuator normally has a low-voltage DC motor, for example, with high rotation speed, with a brush system sliding over a commutator (referred to below as an electric motor or brush-commutated electric motor), and a gear mechanism driven thereby. For maximum torque translation ratio, conventionally several gear stages are provided in the gear mechanism. Firstly, in this way the noise development from high rotation speeds is reduced, and secondly a comparatively high torque is provided which is necessary for braking the motor vehicle.

DE 10 2015 008 568 A1 discloses an actuator in which the gear mechanism is carried by a gear plate. This may be either part of an actuator housing or designed as part of a gear casing which in turn is mounted in the actuator housing. The electric motor is mounted separately in the actuator housing.

It is furthermore possible that a brush-commutated electric motor is inserted in or attached to the gear casing. In a first gear stage, a pinion arranged on a motor shaft of the electric motor meshes with a gear wheel, wherein the motor shaft is mounted in a brush system of the electric motor, and the gear wheel is mounted on an axis in the actuator housing or gear casing. Thus a so-called tolerance chain for the spacing of the gear wheel axis and the pinion shaft is for example, dependent on the tolerances of the motor housing, the actuator housing or gear casing, and the brush system; i.e. the tolerance field for the spacing of the axes of the gear wheel and pinion results from these tolerances.

For the spacing of the axes of a gear wheel and a pinion of a gear stage, and in particular for the spacing of the axis of a gear wheel from a shaft receiving the pinion in the first gear stage, it is desirable for the tolerance field to be as small as possible. In this way, a comparatively high wear and comparatively high noise development at correspondingly high rotation speeds, for example, of the first gear stage, can be avoided. Also, in the first gear stage, because of the comparatively low torque levels, the first gear wheel and pinion may have a correspondingly small modulus.

Corresponding parts in all figures carry the same reference signs.

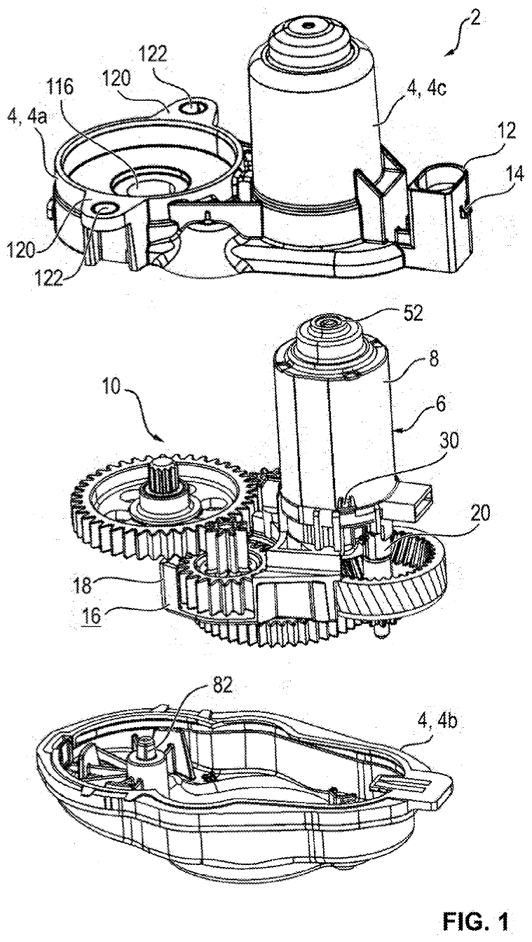

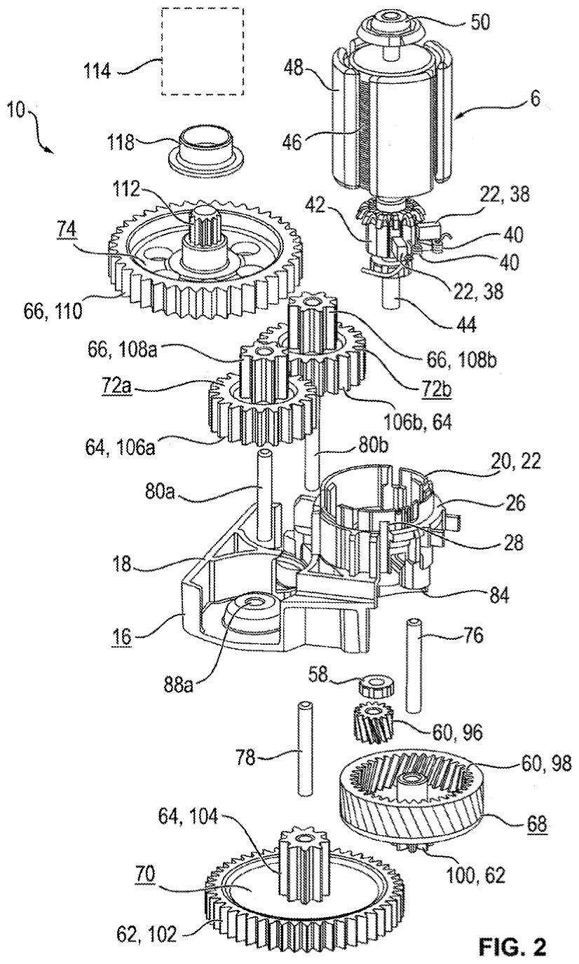

FIG. 1 shows an electrical brake actuator 2 for a motor vehicle (not shown). The brake actuator 2 has an actuator housing 4, which is produced in two pieces with a first housing half-shell 4a and a second housing half-shell 4b. The first housing half-shell 4a has a substantially cylindrical housing region 4c, which covers an electric motor 6 with a motor housing 8 and a part of a gear mechanism 10 of the brake actuator 2 substantially facing the electric motor 6. The individual components of the gear mechanism 10 are shown in detail in FIG. 2.

The first housing half-shell 4a has a push-fit shaft 12 which contains an electrical connection 14 of the electric motor 6 for supply of energy thereto and in some cases control thereof. Advantageously, the push-fit shaft 12 also has a button element 14 for engaging with corresponding contours of a plug-in connector (not shown).

FIG. 2 shows in an exploded view the gear mechanism 10 arranged on a carrier unit 16, and the electric motor 6 arranged on the carrier unit 16 without motor housing 8. Here, the carrier unit 16 is formed by a molding (for example, monolithic) of a gear plate 18 on a substantially pot-like brush carrier 20 of a brush system 22.

It is provided that the brush carrier 20 closes a housing opening of the pot-like motor housing 8. For this, the brush carrier 20 has a base 20a and a brush carrier sleeve 20b which is partially inserted by form-fit into the housing opening. Also, a supporting collar 26 is arranged on the outside of the brush carrier sleeve 20b, and the motor housing is laid thereon. Furthermore, latching contours 28 are provided on the outside of the brush carrier sleeve 20b, and in mounted state receive corresponding latching hooks 30 of the motor housing 8, forming a latching connection.

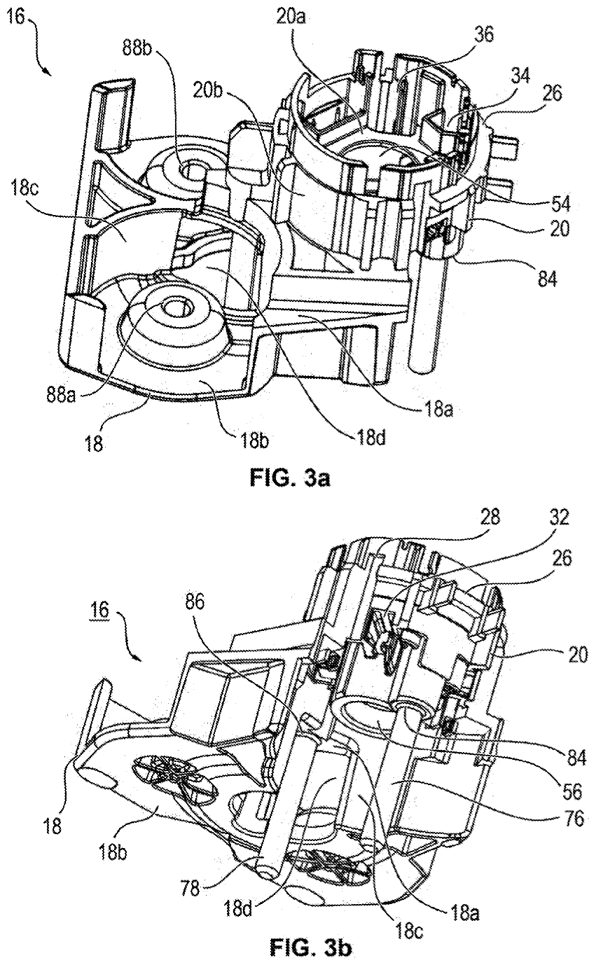

Inside the brush carrier 20, suitable contours (pockets) 32 are provided for receiving, as compactly as possible, brushes 38 of the brush system 20, pockets 34 for receiving anti-interference capacitors (not shown), and pockets 36 for anti-interference chokes (FIGS. 3a and 3b). The anti-interference capacitors and anti-interference chokes serve to improve the electromagnetic compatibility (EMC) of the electric motor 6 relative to further devices (not shown) in the vicinity of the electric motor 6.

The brushes 38 of the brush system 22, which are connected for example to a DC power source, are pressed against a commutator 42 of the electric motor 6 by means of a spring element 40, in order to create a sliding contact. The commutator is connected rotationally fixedly to a motor shaft 44 so as to rotate with the motor shaft 44, whereby the commutator 42 is powered with correct phase by means of the brushes 38. Again, coil windings (not shown for the purposes of greater clarity) are connected to the commutator 42 and suitably arranged on a rotor 46. When the coil windings are powered with the correct phase, the rotor 46 drives the motor shaft 44 (connected rotationally fixedly thereto) because of an interaction of the magnetic field (generated by means of the powered coil winding) with a magnetic field of a stator 48. To minimize eddy current losses, the rotor 46 is configured as a so-called laminated bundle of stacked individual sheets, i.e. the rotor 46 has a structure of several individual sheets (sheet layers) arranged parallel to each other and perpendicularly to the motor shaft 44.

Here, the motor shaft 44 is mounted on the rotor side by means of a spherical bearing 50 which is received in a bearing seat 52 of the motor housing 8. The motor shaft 44 is mounted on the output side via a shaft passage 54 in the base 20a of the brush carrier 20. A base side, facing away from the brush carrier sleeve 20b, also has a raised bearing receptacle 56, surrounding the shaft passage 54 in the manner of a sleeve, for a shaft bearing 58, for example, a plain or sintered bearing.

The gear mechanism 10 is configured with multiple stages. This has a first gear stage 60, a first intermediate stage 62, a second intermediate stage 64 and a final gear stage 66. To form these gear stages, a first double gear wheel 68, a second double gear wheel 70, two third double gear wheels 72a and 72b, and a fourth double gear wheel 74 are provided, wherein these are rotatably mounted accordingly by means of a first bearing axis 76, a second bearing axis 78, two third bearing axes 80a, 80b and a fourth bearing axis 82. The bearing axes 76, 78 and 80a, 80b are received firstly in a respective first bearing seat 84, 86 and 88a, 88b of the carrier unit 16, and secondly in a second bearing seat 90, 92 and 94a, 94b arranged in the actuator housing 4. The fourth bearing axis 82 is formed by a raised monolithic molding which is arranged on the housing inside of the second housing half-shell 4b. The double gear wheels 68, 70, 72a and 72b, and the double gear wheel 74, are mounted by means of the corresponding bearing axes 76, 68, 80a, 80b and 82 axially parallel to the motor shaft 44, so that the gear mechanism 10 is configured as a spur gear mechanism.

In the first gear stage 60, a first pinion 96 fixed to the shaft meshes with an internally toothed first gear wheel 98 of the first double gear wheel 68. The first gear wheel 98 is thus configured as a ring gear. Because of the internal toothing of the first gear wheel 98, the first gear stage 60 is designed compactly with a translation ratio (ü) of more than one (ü>1). Also, the first pinion 96 fixed to the shaft and the first gear wheel 98 meshing therewith have helical toothing, whereby for example, the risk of noise generation at correspondingly high rotation speeds of the first gear stage 60 is reduced.

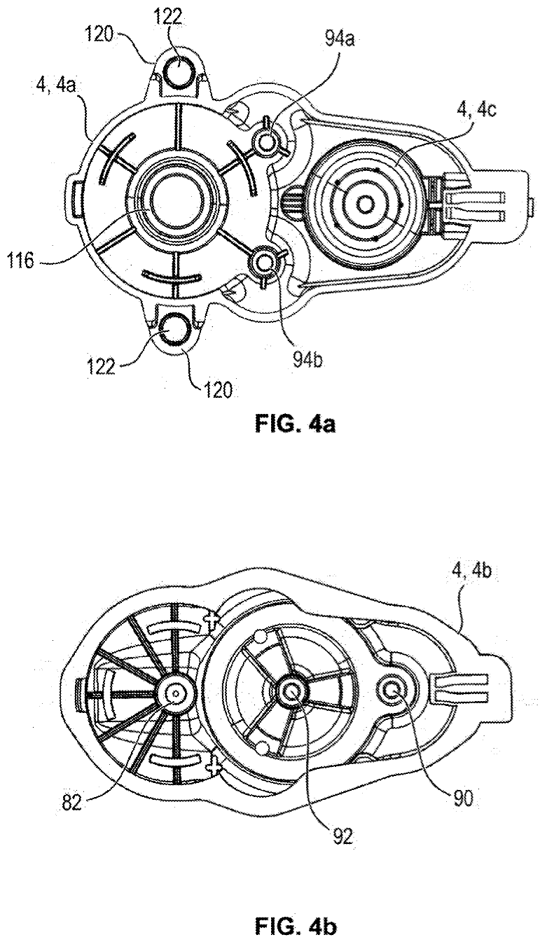

The first gear wheel 98 together with a second pinion 100 forms the first double gear wheel 68, which is mounted rotatably by means of the first bearing axis 76. The first bearing seat 84 of the first bearing axis 76 is arranged in the brush carrier 20 of the carrier unit 16, on the base side facing away from the brush carrier sleeve 20b, and the second bearing seat 90 of the first bearing axis 76 is arranged on the inside of the second housing half-shell 4b of the actuator housing 4 (FIG. 4b).

The second double gear wheel 70 has a second gear wheel 102 and a third pinion 104. The second gear wheel 102 meshes with the second pinion 100 of the first double gear wheel 68, forming the first intermediate stage 62.

The first bearing seat 86 of the second bearing axis 78 is arranged in the gear plate 18 of the carrier unit 16, on its side facing the second housing half-shell 4b, and the second bearing seat 92 of the second bearing axis 78 is arranged on the inside of the second housing half-shell 4b.

The second intermediate stage 64 may include a third pinion 104 of the second double gear wheel 70, which meshes with two gear wheels 106a and 106b of the structurally identical third double gear wheels 72a and 72b. The first two bearing seats 88a and 88b of the two third bearing axes 80a and 80b are each arranged on the side of the gear plate 18 of the carrier unit 16 facing the first housing half-shell 4a. The two second bearing seats 94a and 94b of the two third bearing axes 80a and 80b are arranged in the first housing half-shell 4a of the actuator housing 4 (FIG. 4a).

To receive the gear mechanism 10 compactly, the gear plate 18 of the carrier unit 16 has a stepped form with a first step region 18a and a second step region 18b, which is spaced from the first step region 18a and parallel thereto in the direction of the second housing half-shell 4b, and with a connecting region 18c arranged perpendicularly thereto (FIGS. 3a and 3b). The second double gear wheel 70 and the two third double gear wheels 72a and 72b are mounted such that both the pinion 104 of the second double gear wheel 70, and the two gear wheels 106a and 106b of the third double gear wheel 72a and 72b meshing therewith, are arranged on the gear plate side. Here, the second double gear wheel 70 is arranged on the side facing the second housing half-shell 4b, and the two third double gear wheels 72a and 72b are arranged on the side facing the first housing half-shell 4a. To allow meshing, the second double gear wheel 70 is mounted in the first step region 18a, and the two third double gear wheels 72a and 72b are mounted in the second step region 18b, which is spaced from and parallel to the first step region 18a, wherein the connecting region 18c of the gear plate 18 also has a cutout 18d in the region of the third pinion 104.

In the final gear stage 66, two fourth pinions 108a and 108b of the corresponding third double gear wheels 72a and 72b mesh with an output gear 110.

Because of the parallel connection of the two third double gear wheels 72a and 72b, a power split from the third pinion 104 to the output gear 110 is achieved. Also, wear on the two third pinions 108a and 108b and output gear 110 is reduced.

The output gear 110 together with an output pinion 112 forms the fourth double gear wheel 74, wherein the output pinion 112 is provided for coupling to an output part 114 indicated diagrammatically.

To mount the fourth double gear wheel 74, this is received by the fourth bearing axis 82, wherein the fourth bearing axis 82 is formed on the side of the second housing half-shell 4b facing the gear mechanism 10. Also, the first housing half-shell 4a has a passage 116, raised on the inside of the housing, for the output pinion 112 and for an output gear bearing 118 (FIGS. 1 and 4a).

Furthermore, the first housing half-shell 4a has protruding retaining pockets 120 on the output part side and on the circumference of the passage 116 for the output part 114, with passage bores 122 for mounting at corresponding positions in the motor vehicle (FIGS. 1 and 4a).

The invention is not restricted to the exemplary embodiment described above. Rather, other variants of the invention may be derived therefrom by the person skilled in the art without leaving the subject of the invention. In particular, furthermore all individual features described in connection with the exemplary embodiment may be combined with each other in other ways without leaving the subject of the invention.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE SIGNS

2 Brake actuator
4 Actuator housing
4a First housing half-shell
4b Second housing half-shell
4c Cylindrical housing region
6 Electric motor
8 Motor housing
10 Gear mechanism
12 Push-fit shaft
14 Button element of first housing half-shell
16 Carrier unit
18 Gear plate
18a First step region
18b Second step region
18c Connecting region
18d Cutout
20 Brush carrier
20a Base of brush carrier
20b Brush carrier sleeve
22 Brush system
26 Supporting collar
28 Latching contours of brush carrier
30 Latching hooks of motor housing
32 Pocket for a brush
34 Pocket for an anti-interference capacitor
36 Pocket for an anti-interference choke
38 Brushes
40 Spring element
42 Commutator
44 Motor shaft
46 Rotor
48 Stator
50 Spherical bearing
52 Bearing seat of motor housing
54 Shaft passage
56 Bearing receptacle
58 Shaft bearing
60 First gear stage
62 First intermediate stage
64 Second intermediate stage
66 Final gear stage
68 First double gear wheel
70 Second double gear wheel
72a,b Third double gear wheel
74 Fourth double gear wheel
76 First bearing axis
78 Second bearing axis
80a,b Third bearing axis
82 Fourth bearing axis
84 First bearing seat of first bearing axis
86 First bearing seat of second bearing axis
88a,b First bearing seat of third bearing axis
90 Second bearing seat of first bearing axis
92 Second bearing seat of second bearing axis
94a,b Second bearing seat of third bearing axis
96 First pinion
98 First gear wheel
100 Second pinion
102 Second gear wheel
104 Third pinion
106a,b Third gear wheel
108a,b Fourth pinion
110 Output gear
112 Output pinion
114 Output part
116 Passage
118 Output gear bearing
120 Retaining pocket
122 Passage bore

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An electrical brake actuator for use in a motor vehicle, the electrical brake actuator comprising:
an actuator housing formed by a first housing half-shell and a second housing half-shell;
an electric motor including,
a motor shaft,
a motor housing,
a commutator,
a multi-stage gear mechanism including a first gear stage, configured to be driven by the electric motor and including a first gearwheel, and a final gear stage including an output gear;
a carrier unit including,
a brush carrier defining a base-side shaft passage configured to receive at least a portion of the motor shaft, wherein a first pinion is attached to the motor shaft,
a gear plate monolithically is formed to the brush carrier and including a first bearing seat configured to receive a first bearing axis fixed to the first gearwheel, wherein the first gearwheel meshes with the first pinion.

2. The electrical brake actuator of claim 1, wherein the brush carrier includes a brush carrier sleeve, wherein a bearing receptacle for a shaft bearing is disposed on a
base side of the brush carrier, facing away from the brush carrier sleeve.

3. The electrical brake actuator of claim 1, wherein
a second bearing seat of the first bearing axis is disposed in the second housing half-shell.

4. The electrical brake actuator of claim 1, wherein
the first gearwheel is a ring gear provided with a number of helical teeth.

5. The electrical brake actuator of claim 1, wherein
the multi-stage gear mechanism includes a first intermediate stage and a second intermediate stage each disposed between the first gear stage and the final gear stage.

6. The electrical brake actuator of claim 5, wherein
the first gearwheel and a second pinion of the first intermediate stage form a first double gearwheel.

7. The electrical brake actuator of claim 6, wherein
a second bearing axis receives a second double gearwheel provided with a second gearwheel of the first intermediate stage and a third pinion of the second intermediate stage, wherein the second gearwheel meshes with the second pinion.

8. The electrical brake actuator of claim 7, further comprising:
a first bearing seat disposed in the gear plate and configured to receive the second bearing axis; and
a second bearing seat disposed in the second housing half-shell and configured to receive of the second bearing axis.

9. The electrical brake actuator of claim 7, further comprising:
a third double gearwheel including,
a first third bearing axis and a second third bearing axis, and
a first third gearwheel and a second third gearwheel, wherein the first third bearing axis receives the first third gearwheel and the second third bearing axis receives the second third gearwheel and wherein the third pinion meshes with the first and second third gearwheels.

10. The electrical brake actuator of claim 9, wherein
a first bearing seat of the first third bearing axis is disposed in the gear plate, and a second bearing seat of the second third bearing axis is arranged in the first housing half-shell.

11. The electrical brake actuator of claim 10, further comprising
a first fourth pinion meshed with the first third gearwheel and a second fourth pinion meshed with the second third gearwheel, wherein the first and second third gearwheels mesh with the output gear.

12. The electrical brake actuator of claim 11, further comprising:
an output pinion configured to be coupled to an output part and meshed with the output gear, wherein the output pinion and output gear form a
fourth double gearwheel.

13. The electrical brake actuator of claim 12, wherein
the first housing half-shell defines a passage, wherein the passage is raised away from an exterior side of the housing and is configured to receive the output pinion and an output gear bearing.

14. The electrical brake actuator of claim 1, wherein a fourth bearing axis is disposed in the second housing half-shell and wherein
the output gear is received by the fourth bearing axis.

15. The electrical brake actuator of claim 1, wherein
the gear plate includes a first step region, a second step region, and a connecting region arranged perpendicular to the first step region, wherein the second step region defines a cutout.

16. The electrical brake actuator of claim 15, wherein
the first bearing axis, second bearing axis, third bearing axis, and fourth bearing axis are each arranged axially parallel to the motor shaft.

17. An electrical brake actuator for use in a motor vehicle, the electrical brake actuator comprising:
an actuator housing formed by a first housing half-shell and a second housing half-shell;
an electric motor including a motor shaft;
a multi-stage gear mechanism including a first gear stage, configured to be driven by the electric motor and including a first gearwheel, and a final gear stage including an output gear; and
a carrier unit including,
a brush carrier defining a base-side shaft passage configured to receive at least a portion of the motor shaft, wherein a first pinion is attached to the motor shaft, and
a gear plate monolithically formed to the brush carrier and including a first bearing seat configured to receive a first bearing axis fixed to the first gearwheel, wherein the first gearwheel is a ring gear provided with a number of helical teeth configured to mesh with the first pinion.

18. The electrical brake actuator of claim 17, wherein the multi-stage gear mechanism includes a first intermediate stage and a second intermediate stage, wherein the first intermediate stage includes a second gearwheel and a second pinion, wherein the second intermediate stage includes a third pinion, wherein the second gearwheel meshes with the third pinion.

19. An electric brake actuator for use in a motor vehicle, the electric brake actuator comprising:
an electric motor;
a multi-stage gear mechanism including a first gear stage, configured to be driven by the electric motor and a final gear stage including an output gear and an output pinion, wherein the output pinion is configured to engage an output part; and
an actuator housing configured to receive the electric motor and the multi-stage gear mechanism, wherein a portion of the actuator housing includes a protrusion defining a passage, wherein the passage receives the output pinion.

20. The electric brake actuator of claim 19, wherein the actuator housing includes a first shell and a second shell, wherein the first shell includes a cylindrical housing configured to receive the motor and the second shell includes the protrusion.
